(19) United States
(12) Patent Application Publication
(10) Pub. No.: US 2010/0008963 A1
(43) Pub. Date: Jan. 14, 2010

(54) BAITING METHOD AND COMPOSITION

(75) Inventors: Michael O'Donoghue, Victoria (AU); James Alan Morris, Victoria (AU); Michael James Johnston, Victoria (AU); Michael James Lindeman, Victoria (AU)

Correspondence Address: SCHWEGMAN, LUNDBERG & WOESSNER, P.A., P.O. BOX 2938, MINNEAPOLIS, MN, 55402, US

(73) Assignee: Commonwealth of Australia as represented by & acting through the Dept. of Environment Water...., Parkes (AU)

(21) Appl. No.: 12/500,851

(22) Filed: Jul. 10, 2009

(30) Foreign Application Priority Data
Jul. 11, 2008 (AU) 2008903572

(51) Int. Cl. A01N 25/08; A01P 19/00

(52) U.S. Cl. 424/410; 424/84

(57) ABSTRACT

The present invention provides a delivery device for use in the control of a target animal species, the delivery device including:
(a) a core containing a control agent for the target animal species,
   and
(b) an impermeable coating enclosing the core, the coating being selected to provide exposure of the core in the gastrointestinal tract of the target animal species;
   wherein the coating of the delivery device has a hardness such that the coating is not readily breached upon mastication by a target or non-target animal species and further wherein the delivery device will not pass through a Tyler 5 mesh.

### RELATED APPLICATION

This application claims the benefit of priority, under 35 U.S.C. Section 119, to Australian Patent Application Serial No. 2008903572, filed on Jul. 11, 2008, which is incorporated herein by reference in its entirety.

### FIELD OF THE INVENTION

The present invention relates to methods for control of target animal species based on the eating behaviour of the target animal species and delivery devices for use in the methods. Accordingly the present invention relates to a delivery device for use in the control of target animal species and a method of controlling target animal species using the delivery device. In particular the invention relates to a delivery device suitable for use especially in the control of felids, canids and mustelids (such as cats, dogs, foxes, stoats, ferrets, weasels and the like) and to a method of providing and using this delivery device to selectively control these species.

### BACKGROUND OF THE INVENTION

The control of target animal species within an environment is very important both in a farming sense and in an environmental conservation sense. In certain areas there is a pressing need to control populations of species as they may endanger the environment into which they have been introduced or find themselves in.

As man has spread throughout the world he has taken with him many animals that were thought at the time to be useful for a variety of reasons. Unfortunately many of these animals have either escaped from their domesticated state (such as with cats and dogs) or have been introduced into the wild (as is the case with foxes and rabbits in Australia) and the spread of these non-native (“feral and/or invasive” and exotic) animals threatens the long term survival of many native species and communities. By way of example, rabbits modify a landscape by preferential browsing leading to significant changes in vegetation communities. This is especially true where the feral and/or invasive or exotic species is a predatory species as in many instances the predator has the potential to eradicate native fauna through uncontrolled predation.

The effort to manage populations of such species may necessarily be on-going. For instance in certain circumstances a target species may be controlled through shooting programs aimed at the specific eradication of the target species. Whilst this technique is highly selective and reasonably effective it is very expensive due to the requirement for highly skilled labour to carry it out. In addition shooting as an eradication technique is not readily applicable to large land areas as the area to be covered is often so unmanageable as to be uneconomic. Standing vegetation can also reduce the efficiency of shooting programs.

An alternative technique that is sometimes used is trapping of the target animal species to be eradicated. This technique suffers many of the drawbacks of shooting in that skilled staff are required and the technique becomes unworkable once the area to be treated exceeds a certain minimum size. By way of example, trapping of a target animal species once the area of land reaches a certain size quickly becomes uneconomic. In addition trapping is not selective and so can lead to the death of non-target animal species through physical injuries sustained during the trapping process or by the stress caused to non-target animal species because of the trapping process.

Yet an even further alternative is biological control of the target animal species. This approach has the possibility of high success but requires extensive R&D for any particular agent to be effective and follow-up using conventional control techniques.

In essence to date the only method available for the control of a target animal species on a large scale has entailed baiting techniques where baits are laid in the anticipation that the target animal species will be more readily affected by the bait than non-target animal species. For example poison baiting for cat, fox and wild dog control using “1080” (sodium fluoroacetate) is currently utilised to a limited extent in parts of Western Australia where native species typically display a high tolerance to the 1080 poison. In eastern Australia this tolerance does not exist and in circumstances where such poison baits are used they are generally buried to reduce the potential consumption of the baits by non-target animal species. This creates two problems. In respect of feral cats specifically, they rarely exhume buried baits. In addition the requirement to bury the baits means that the technique is not readily applied to treating large areas due to the costs and logistics involved.

In order to overcome these problems there have been a number of attempts to develop selective poisons for targeting animal species in the hope that the problems associated with consumption of the bait by non-target animal species could be eliminated. Whilst there has been some success using these techniques, at least to date no truly selective poison ‘bait’ system has been developed. Target animal species specificity using the poisons developed so far has not been acceptable. Accordingly there is still a need to develop improved materials and/or methods that can be used in the baiting of target animal species.

It has now been found that certain levels of target animal species specificity can be achieved by taking advantage of the eating behaviour of the particular target animal species. In particular, an eating behaviour that can be used to advantage is the differences in level of mastication of food eaten by the target animal species compared to non-target animal species. Certain species masticate their food prior to consumption and so a delivery device can be applied that will be rejected by a species of this type. In contrast there are certain species, such as cats and the like, that typically do not masticate their food thoroughly and they therefore do not reject the delivery device. Thus, it has been observed that many target animal species do not masticate their food thoroughly but rather they tend to swallow whole portions of the food. In contrast many non-target animal species tend to masticate food prior to swallowing it. Accordingly if a control agent (such as a poison) is present in the form of a delivery device of sufficient size and hardness then the control agent is not ingested by many non-target animal species because they reject the delivery device. Without wishing to be bound by theory it is felt that the rejection is based on the characterisation of the delivery device as a rock or stone or some such indigestible material by the non-target animal species. In contrast target animal species tend to swallow their food whole and thus the same delivery device is ingested. It has now been found that in order to take advantage of this difference the delivery device containing the control agent must be of a certain size and hardness (so as to mimic a rock or the like and be rejected) and should also not release appreciable amounts of the control agent in the mouth and so must be formulated to ensure that this does not happen.

In addition it has been found that higher levels of specificity can be achieved by taking advantage of a combination of the eating habits of the target animal species versus non-target animal species as discussed above and the susceptibility of the target animal species to one or more specifically chosen control agents.

### SUMMARY OF THE INVENTION

The present invention is therefore based on the finding that control of a target animal species can be achieved by taking advantage of the differential eating behaviours of target versus non-target animal species and combining it with differential control agent susceptibility/specificity in order to obtain acceptable levels of target animal species specificity. A particularly suitable eating behaviour that can be used to differentiate a target animal species from a non-target animal species is the degree to which the target animal species masticates its food prior to consumption. It has been found that specificity for a target animal species can be achieved by providing a control agent in the form of a delivery device of a defined size and hardness including a combination of a coating and a core, the latter containing the control agent, and the former ensuring that appreciable amounts of the control agent is released in the gastrointestinal tract and not in the mouth or into the bait prior to its being consumed. Ensuring that appreciable amounts of the control agent is not released in the mouth or into the bait is important as it means that there is no release of the control agent in the mouth of a non-target animal species prior to their rejection of the delivery device. Also, in the case of the target animal species there is no rejection of any part of the dose (due to, by way of example, taste impalatability) and thus a minimal dose of the control agent can be used, minimising potentially adverse environmental effects through use of a minimum dose and also providing for greater selectivity where dose rate (mass of control agent per unit mass of body weight) varies with species.

In one aspect the present invention provides a delivery device for use in the control of a target animal species, the delivery device including:

(a) a core containing a control agent for the target animal species; and

(b) an impermeable coating enclosing the core, the coating being selected to provide exposure of the core in the gastrointestinal tract of the target species;

wherein the coating of the delivery device has a hardness such that the coating is not readily breached upon mastication by a target or non-target animal species and further wherein the delivery device will not pass through a Tyler 5 mesh.

The hardness of the delivery device is important as in order to achieve effective rejection of the delivery device any non-target animal species must consider the delivery device to be solid and reject it. Accordingly, it is necessary that the delivery device coating has a hardness such that the coating is not readily breached upon mastication by a target or non-target animal species. In one embodiment the coating formulation of the delivery device has a hardness of at least 50 on the Shore D scale. In another embodiment the coating formulation of the delivery device has a hardness of at least 60 on the Shore D scale. In another embodiment the coating formulation of the delivery device has a hardness of at least 70 on the Shore D scale.

In order to ensure acceptable rates of rejection of the delivery device by a non-target species it is also desirable that the delivery device be sufficiently large so that non-target animal species detect the presence of the delivery device in the mouth and have the opportunity to reject it. Small delivery devices are not detected and are therefore swallowed by both target and non-target animal species. As stated above, in order to achieve this it is important that the delivery device will not pass through a Tyler 5 mesh. In one embodiment the delivery device will not pass through a Tyler 4 mesh. In one embodiment the delivery device will not pass through a Tyler 3½ mesh. In one embodiment the delivery device will not pass through a Tyler 3 mesh. In one embodiment the delivery device will not pass through a Tyler 2½ mesh.

The delivery device of the invention may be used to target any animal species that is in the habit of swallowing food in portions rather than masticating (chewing) the food prior to swallowing. In one embodiment the target animal species is selected from the group consisting of canids, felids and mustelids. In one embodiment the target animal species is selected from the group consisting of cats, bobcats, dogs, foxes, coyotes, stoats, ferrets and weasels. In a specific embodiment the target species is a cat (Felis domesticus).

The control agent may be any suitable control agent which upon ingestion leads to control of the target animal species. The control agent may suitably be selected from the group consisting of a toxicant, an appetite suppressant, a contraceptive, or a vaccine.

In one embodiment the control agent is a toxicant. The toxicant may be any suitable toxicant known in the art to achieve the desired kill rate upon ingestion by the target animal species. It is desirable that the toxicant selected demonstrates some selectivity for the target animal species. In one embodiment of the invention the toxicant exhibits selectivity for the target animal species. In a specific embodiment the toxicant is p-aminopropiophenone or a salt thereof.

The delivery devices of the invention contain a core and a coating. The relative amounts of core and coating will vary typically depending upon the size and shape of the delivery device. In general it is found that the larger the delivery device the smaller the percentage of the delivery device that is taken up by the coating and the larger the percentage that is taken up by the core.

In a typical embodiment, however, the core represents from 10% to 90% w/w of the delivery device. In another embodiment the core represents from 30% to 70% w/w of the delivery device. In yet an even further embodiment the core is about 50% w/w of the delivery device.

The core of the delivery device may contain one or more additional additives that may aid in the performance of the delivery device. For example, it may be found that it is desirable that the core be formulated in order to ensure ease of processing. In order to aid processing of the core material it may be necessary to incorporate additional components including a carrier. Additional components might include:
(i) plasticisers, dibutyl sebacate [CAS # 109 43 3], polypropylene glycol [CAS # 25322 69 4], Beeswax [CAS # 8012 89 3], or stearyl alcohol;
(ii) solubilising agents, such as PEG's {polyethylene glycols [CAS # 25322 68 3]}, or Vitamin E TPGS [CAS # 30999-06-5];
(iii) lubricants, such as magnesium stearate;
(iv) surfactant materials or other surface active molecules (e.g., biological detergents such as Span's, Tween's or Teric's and proteins, such as albumins);
(v) flow promoters;
(vi) anti-sticking agents;
(vii) anti-static agents; and/or
(viii) other materials as would be apparent to those skilled in the art.

Further, and by way of example, it may be found that it is desirable that the core be formulated in order to ensure rapid release of the control agent in the gastrointestinal tract of the animal rather than providing sustained release. This is because release of the control agent rapidly in a substantially single pulse ensures the attainment of the highest concentration of the control agent in the body of the target species typically leading to maximal efficacy, such as the most humane death of the target species when the control agent is a toxicant. Accordingly it is desirable that the core of the delivery device contains additives that assist in the rapid release of the control agent from the core. Thus, in one embodiment of the invention the core contains a solubilizer. Any suitable solubilizer may be used with a particularly suitable group of solubilisers being the polyethylene glycols. In one specific embodiment the polyethylene glycol solubilizer is PEG6000.

The amount of solubilizer used may vary considerably depending upon the amount of control agent in the core and the like. Nevertheless if a solubilizer is used it typically represents from 90% to 50% w/w of the core. In one embodiment the solubilizer represents from 70% to 50% w/w of the core. In a specific embodiment the solubilizer represents about 50% w/w of the core.

The core may also contain disintegrant to aid in the rapid dispersion of the core and thus enable rapid dispersement of the control agent from the core. Any suitable disintegrant well known in the art may be used. In one embodiment the disintegrant is selected from the group consisting of starches, vinylpyrollidone analogues, clays, cellulosic's, algins, gums and effervescent agents. In one embodiment the disintegrant is a starch grafted sodium polyacrylate.

The disintegrant may be present at any suitable amount in the core. In one embodiment the disintegrant represents from 5% to 25% w/w of the core. In a specific embodiment the disintegrant represents about 25% w/w of the core.

The coating encloses the core of the delivery device. The coating may be a single layer coating or a multilayer coating.

As stated previously the coating is selected to provide exposure of the core in the gastrointestinal tract of the target animal species. In one particular embodiment the core provides rapid exposure of the core in the gastrointestinal tract of the target animal species. In general this may be readily achieved by selection of the appropriate coating that will dissolve under the pH conditions of the desired location of the gastrointestinal tract for release to occur and/or after a specifically desired transit time in the gastrointestinal tract. In one embodiment the coating provides rapid exposure of the core in the stomach of the target species. This is typically achieved by selection of a coating that will dissolve in the acidic environment of the gastric fluid in the stomach, i.e. at a pH of less than 5.0. An example of a suitable coating material is Eudragit® E100.

The coating of the delivery device may contain one or more additional additives that may aid in the performance of the delivery device. For example, it may be found that it is desirable that the coating be formulated in order to ensure ease of processing or to increase hardness. In order to aid processing or increase the hardness of the coating matrix it may be necessary to incorporate additional components. Additional components might include:
(i) plasticisers, dibutyl sebacate [CAS # 109 43 3], polypropylene glycol [CAS # 25322 69 4], Beeswax [CAS # 8012 89 3], or stearyl alcohol;
(ii) solubilising agents, such as PEG's {polyethylene glycols [CAS # 25322 68 3]}, or Vitamin E TPGS [CAS # 30999-06-5];
(iii) lubricants, such as magnesium stearate;
(iv) surfactant materials or other surface active molecules (e.g. biological detergents such as Span's, Tween's or Teric's and proteins, such as albumins);
(v) flow promoters;
(vi) anti-sticking agents;
(vii) anti-static agents; and/or
(viii) other materials as would be apparent to those skilled in the art.

In application of the invention, all such additional components are preferably at least substantially pure, may or may not be non-toxic in the amounts used, and are compatible with the bioactive(s) used and with the core and/or coating materials.

In yet an even further aspect the invention provides a method of controlling a target animal species in an environment containing the target animal species the method utilising the eating behaviour of the target animal species to selectively control the target animal species. In one embodiment the method includes providing a bait that will be eaten or consumed by the target animal species but that may or may not be eaten or consumed by a non-target animal species in part or whole. In one embodiment the eating behaviour is the level of mastication of food eaten or consumed by the target animal species.

In one embodiment the method includes laying a bait in the environment, the bait including:

(i) a delivery device including:
(a) a core containing a control agent for the target animal species; and
(b) an impermeable coating enclosing the core, the coating being selected to provide exposure of the core in the gastrointestinal tract of the target species;
wherein the delivery device coating has a hardness such that the coating is not readily breached upon mastication by a target or non-target animal species and further wherein the delivery device will not pass through a Tyler 5 mesh;
   and
   (ii) an attractant.

The bait that is laid may take any of a wide variety of forms known in the art. In general, however, the bait is configured such that the attractant is located around the delivery device. Any suitable attractant may be used that will entice the target animal species to consume the bait. In one embodiment the attractant is meat or a meat product for attracting a carnivore or omnivore.

The baits may be laid in any way known in the art. They may be laid manually in which case they are placed in the desired location by the person applying the baits to the environment containing the target species. Alternatively, in many instances it is more economical to lay the baits aerially in which case they are dropped from an aircraft as it travels over the environment containing the target species. The baits may be laid in any suitable concentration although typically they are laid in the environment at from 10 to 1000 baits per square kilometre. In one embodiment the baits are laid in the environment at from 30 to 70 baits per square kilometre. In another embodiment the baits are laid in the environment at about 50 baits per square kilometre. In a further embodiment of the method of the invention the delivery device used contains the features of the delivery devices described above.

### DETAILED DESCRIPTION OF THE INVENTION

The present invention is based on the finding that specificity for certain target animal species can be achieved by taking advantage of the eating behaviour of the target animal species versus the eating behaviour of a non-target animal species. In particular specificity can be obtained by providing a control agent in the form of a delivery device with certain physical characteristics. Selection of the correct combination of physical characteristics of the delivery device leads to rejection of the delivery device by non-target animal species but ingestion of the delivery device by the target animal species.

One important physical characteristic of the delivery device is the delivery device hardness. This is important as in order to achieve effective rejection of the delivery device the non-target animal species must consider the delivery device to be solid (such as a rock or some such indigestible material) and reject it. In order for this to happen the delivery device must not be readily breached upon chewing of the delivery device which will invariably occur when an animal eats the bait containing the delivery device. If the delivery device does break down under these conditions there will not only be release of the control agent in the mouth of the animal eating the bait but in addition there will not necessarily be rejection of the delivery device by non-target animal species leading to a loss of specificity for the target animal species. The hardness of the delivery device is important as in order to achieve effective rejection of the delivery device any non-target animal species must consider the delivery device to be solid and reject it. Accordingly, it is necessary that the delivery device (coating) has a hardness such that the coating is not readily breached upon mastication by a target or non-target animal species. In one embodiment the coating formulation of the delivery device has a hardness of at least 50 on the Shore D scale. In another embodiment the coating formulation of the delivery device has a hardness of at least 60 on the Shore D scale. In another embodiment the coating formulation of the delivery device has a hardness of at least 70 on the Shore D scale.

Rejection of the delivery device by non-target animal species is also based in part upon the size of the delivery device. It is important that the dimensions of the delivery device be such that non-target animal species detect the presence of the delivery device in the mouth and/or within the bait and have the opportunity to reject it by spitting it out and the like. Alternatively if the non-target animal species is small enough then they will nibble the attractant from around a sufficiently large delivery device and thus not ingest the control agent. It is observed that if the delivery devices are too small then they are not detected by either the target or non-target animal species and are therefore swallowed by both target and non-target animal species. This of course leads to a complete loss of specificity in the ingestion of the delivery devices in baits for the target animal species and any specificity for the target animal species becomes solely dependent then upon difference of susceptibility between target and non-target animal species for the control agent. Accordingly it is desirable that the delivery device be sufficiently large that it can be detected by a significant portion of the non-target animal species. In order to achieve this it is important that the delivery device will not pass through a Tyler 5 mesh. In one embodiment the delivery device will not pass through a Tyler 4 mesh. In one embodiment the delivery device will not pass through a Tyler 3½ mesh. In one embodiment the delivery device will not pass through a Tyler 3 mesh. In one embodiment the delivery device will not pass through a Tyler 2½ mesh.

Tyler mesh size indicates exactly the number of openings per linear inch of mesh. For instance, a Tyler number 4 mesh will have 4 openings per linear inch, and openings per square inch. This numbering system results in higher numbered meshes having smaller openings. Table 1 below shows the Tyler Mesh sizes referred to in this application and the size of the openings in the mesh is provided to assist the reader in an understanding of this application.

TABLE 1
Tyler Mesh Sizes

| | |
|---|---|
| Tyler Mesh Size | Size of Opening |

| | | |
|---|---|---|
| 2½ | Mesh | 8.00 mm |
| 3 | Mesh | 6.73 mm |
| 3½ | Mesh | 5.66 mm |
| 4 | Mesh | 4.76 mm |
| 5 | Mesh | 4.00 mm |

The delivery devices of the invention may be any of a wide variety of shapes with the shape being determined in each instance by the end use application desired and the method of manufacture of the delivery device. The delivery device may be elongate or it may be substantially spherical.

The delivery devices of the invention may be used to target any animal species that is in the habit of swallowing food in portions rather than masticating (chewing) the food prior to swallowing. There are a large number of animal species that fall into this category. A large number of the predatory feral and/or invasive species found throughout the world fall into this category including felids, canids and mustelids.

In one embodiment the target species is selected from the group consisting of cats, coyotes, dogs, stoats, bobcats, foxes, ferrets and weasels. In a specific embodiment the target species is a cat.

The delivery devices of the invention contain a control agent for the target animal species in the core of the delivery device. The control agent may be of any suitable type but is typically selected from the group consisting of toxicant(s), appetite suppressant(s), contraceptive(s), and vaccine(s) depending upon the level and/or desired manner for control of the target animal species required.

In some instances the target animal species is such that the level of control required is eradication such that as many of the target animal species are removed from the environment as possible. This is the case with feral cats for example and in this instance the control agent is typically a toxicant that leads to death. In other instances, however, control may be aimed at reducing the number of animals in an environment, such as where the number of a target animal species on an island is reaching an unsustainable population, and in this instance contraception may be more appropriate and so the control agent may be a contraceptive.

As used herein a “toxicant” is a chemical compound that has a deleterious effect on an organism typically leading to death. Accordingly, a toxicant for a target animal species is a chemical compound that has a deleterious effect on the target animal species. The toxicant may be any suitable toxicant known in the art to achieve the desired kill rate upon ingestion by the target animal species. A number of toxicants are known in the art and the exact choice of toxicant will be determined by the target animal species that it is intended be targeted by the delivery device. Toxicants might include:
(i) p-aminopropiophenone;
(ii) sodium monofluoroacetate (“1080”);
(iii) salicylic acid, acetylsalicylate, and/or salts thereof;
(iv) acetaminophen;
(v) zinc phosphide;
(vi) hydrogen cyanide, and cyanide salts;
(vii) anti-coagulants—1^{st} and 2^{nd} generation (e.g. warfarin, pindone, brodifacoum, etc.); and
(viii) such other suitable materials, the nature of which would be apparent to those skilled in the art.

The toxicant employed may be a broad spectrum toxicant or it may be a toxicant with specificity for one or more target animal species. Nevertheless it is desirable that the toxicant selected demonstrates some selectivity for the target animal species. An example of a toxicant of this type is p-aminopropiophenone or a salt thereof. This toxicant is found to have higher levels of toxicity for certain animals in contrast to other animals. Table 2 below shows the LD₅₀ for this toxicant in a number of species.

TABLE 2
LD₅₀ of p-aminopropiophenone.

| | | LD₅₀ |
|---|---|---|
| Target | Route | (mg kg⁻¹) |
| Cat (Fellis libyca domestica) | Oral | 5.6 |
| Coyote (Canis latrans) | Oral | 5.6 |
| Dogs (Canis familaris) | Oral | 7.5 (>7) {50} |
| Stoats (Mustela erminea) | Oral | 9.3 |
| Bobcat (Lynx rufus) | Oral | 10 |
| Fox (kit) (Vulpes velox) | Oral | 14.1 |
| Ferret (Mustela putoris furo) | Oral | 29 |
| Mallard (duck) (Anas platyrhrynchos) | Oral | 38 |
| Eagle (Aquila chrysaetos) | Oral | >50 |
| Tammar wallaby (Macropus eugenii) | Oral | 89 |
| Badger (Nth Am.) (Taxidea taxus) | Oral | 100 |
| Blackbird (red-wing) (Agelaius phoenicus) | Oral | 133 |
| Raccoon (Procyon lotor) | Oral | 142 |
| Mouse (male) (Mus domesticus) | I.V. | 145 |
| Mouse (male) (Mus domesticus) | Oral | 168 (233) |
| Rat (male) (Rattus norvegicus) | Oral | 177 |
| Magpie (black-billed) (Pica pica) | Oral | 178 |
| Crow (Corvus brachyrhynchos) | Oral | >178 |
| Mouse (female) (Mus domesticus) | I.V. | 200 |
| Rat (female) (Rattus rattus) | Oral | 224 (59) |
| Mouse (male) (Mus domesticus) | I.P. | 223 (233) |
| Mouse (Mus domesticus) | Oral | 233 |
| Rat (Rattus rattus) | I.P. | 273 (85) |
| Starling (Sturnus vulgaris) | Oral | >316 |
| Quail (Coturnix coturnix) | Oral | >316 |
| Skunk (Mephitis mephitis) | Oral | >400 |
| Rat (male) (Rattus rattus) | Oral | 475 (47) {221} |
| Brushtail Possum (Trichosaurus vulpecula) | Oral | 500 |
| Guinea pig (female) (Cavellio porcinus) | Oral | 1020 |
| Mouse (female) (Mus domesticus) | Oral | >5,000 |

As can be seen from the table, p-aminopropiophenone shows excellent selectivity for cats, dogs, bobcats, stoats and foxes in comparison to other species. It is therefore especially applicable to use in the control of these species.

The amount of control agent used will vary considerably. However it is typical that the control agent represents from 20% to 80% w/w of the core. In one embodiment the control agent represents from 40% to 60% w/w of the core. In a specific embodiment the control agent represents about 50% w/w of the core.

The delivery devices of the invention consist of a core and a coating. The relative amounts of core and coating will vary typically depending upon the size and shape of the delivery device. In general it is found that the larger the delivery device the smaller the percentage of the delivery device taken up by the coating and the larger the percentage taken up by the core. In a typical embodiment, however, the core represents from 10% to 90% w/w of the delivery device. In another embodiment the core represents from 30% to 70% w/w of the delivery device. In yet an even further embodiment the core is about 50% w/w of the delivery device.

It is often found that it is desirable that the core of the delivery device be formulated in order to ensure rapid release of the control agent in the gastrointestinal tract of the animal rather than providing sustained release. This is because release of the control agent rapidly in a substantially single pulse ensures attainment of the highest concentration of the control agent in the body of the target species typically leading to maximal efficacy, such as the most humane death of the target species when the control agent is a toxicant. Accordingly it is often desirable that the core of the delivery device contain additives that assist in the rapid release of the control agent from the core.

The core of the delivery device may contain one or more additive(s) that aid in the performance of the delivery device. In the present context the term “additive” is intended to denote any material which is inert in the sense that it substantially has no control agent effect per se. Such additive(s) may be incorporated with the purpose of making it possible to obtain a final delivery device which has the desired final properties.

Examples of suitable additives for use in the core of a delivery device according to the invention include fillers, diluents, glidants, disintegrants, binders, lubricants, etc., acidifying agents, alkalizing agents, preservatives, antioxidants, buffering agents, chelating agents, colouring agents, complexing agents, emulsifying and/or solubilizing agents, surfactants, flavours and perfumes, humectants, sweetening agents, wetting agents and the like or mixtures thereof.

Examples of suitable fillers, diluents and/or binders include lactose (e.g. spray-dried lactose, α-lactose, β-lactose, Tabletose, various grades of Pharmatose, Microtose or Fast-Floc), microcrystalline cellulose (various grades of Avicel, Elcema, Vivacel, Ming Tai or Solka-Floc), hydroxypropylcellulose, l-hydroxypropylcellulose (low substituted), hydroxypropyl methylcellulose (e.g. Methocel E, F and K, Metolose SH of Shin-Etsu, Ltd, such as, e.g. the 4,000 cps grades of Methocel E and Metolose 60 SH, the 4,000 cps grades of Methocel F and Metolose 65 SH, the 4,000, 15,000 and 100,000 cps grades of Methocel K; and the 4,000, 15,000, 39,000 and 100,000 grades of Metolose 90 SH), methylcellulose polymers (such as, e.g., Methocel A, Methocel A4C, Methocel A15C, Methocel A4M), hydroxyethylcellulose, sodium carboxymethylcellulose, carboxymethylene, carboxymethylhydroxyethylcellulose and other cellulosic derivatives, sucrose, agarose, sorbitol, mannitol, dextrins, maltodextrins, starches or modified starches (including potato starch, maize starch and rice starch), calcium phosphate (e.g. basic calcium phosphate, calcium hydrogen phosphate, dicalcium phosphate hydrate), calcium sulfate, calcium carbonate, sodium alginate, collagen and the like.

Specific examples of diluents include calcium carbonate, dibasic calcium phosphate, tribasic calcium phosphate, calcium sulfate, microcrystalline cellulose, powdered cellulose, dextrans, dextrin, dextrose, fructose, kaolin, lactose, mannitol, sorbitol, starch, pregelatinized starch, sucrose, sugar, etc.

Specific examples of binders include acacia, alginic acid, agar, calcium carrageenan, sodium carboxymethylcellulose, microcrystalline cellulose, dextrin, ethylcellulose, gelatine, liquid glucose, guar gum, hydroxypropyl methylcellulose, methylcellulose, pectin, polyethylene glycol's, povidone, pregelatinized starch, etc.

The core may also contain disintegrant to aid in the rapid release of the control agent from the core. Any suitable disintegrant well known in the art may be used. In one embodiment the disintegrant is selected from the group consisting of starches, vinylpyrollidone analogues, clays, cellulosic's, algins, gums and effervescent agents. Specific examples of disintegrants are, e.g., alginic acid or alginates, microcrystalline cellulose, hydroxypropyl cellulose and other cellulose derivatives, croscarmellose sodium, crospovidone, polacrillin potassium, sodium starch glycolate (Explotab®), starch, pregelatinized starch, carboxymethyl starch (e.g. Primogel®), etc. In one embodiment the disintegrant is a starch grafted acrylic acid disintegrant.

The disintegrant may be present at any suitable amount in the core. In one embodiment the disintegrant represents from 5% to 25% w/w of the core. In a specific embodiment the disintegrant represents about 25% w/w of the core.

Other additives which may be included in the delivery device of the invention include flavouring agents, colouring agents, taste-masking agents, pH-adjusting agents, buffering agents, preservatives, stabilizing agents, anti-oxidants, wetting agents, humidity-adjusting agents, anti-emetic agents, surface-active agents, plasticising agents, suspending agents, absorption enhancing agents, agents for modified release, etc.

Another additive that may be present in the delivery devices of the invention is an anti-oxidant such as, by way of example, ascorbic acid, ascorbyl palmitate, butylated hydroxyanisole, butylated hydroxytoluene, hypophosphorous acid, monothioglycerol, potassium metabisulfite, propyl gallate, sodium formaldehylde sulfoxylate, sodium metabisulfite, sodium thiosulfate, sulfur dioxide, tocopherol, tocopherol acetate, tocopherol hemisuccinate, TPGS or other tocopherol derivatives, etc.

In one embodiment of the invention the core contains one or more solubilising agents. It is contemplated that such substances are involved in the wetting of a slightly soluble active substance and thus contribute to improved solubility characteristics of the active substance. Any suitable solubilising agent well known in the art may be used.

Specific examples of suitable solubilising agents are polyethoxylated fatty acids such as, by way of example, fatty acid mono- or di-esters of polyethylene glycol or mixtures thereof such as, e.g. mono- or di-esters of polyethylene glycol with lauric acid, oleic acid, stearic acid, myristic acid, ricinoleic acid, and the polyethylene glycol may be selected from PEG 4, PEG 5, PEG 6, PEG 7, PEG 8, PEG 9, PEG 10, PEG 12, PEG 15, PEG 20, PEG 25, PEG 30, PEG 32, PEG 40, PEG 45, PEG 50, PEG 55, PEG 100, PEG 200, PEG 400, PEG 600, PEG 800, PEG 1000, PEG 2000, PEG 3000, PEG 4000, PEG 5000, PEG 6000, PEG 7000, PEG 8000, PEG 9000, PEG 10,000, PEG 15,000, PEG 20,000, PEG 35,000, polyethylene glycol glycerol fatty acid esters, i.e. esters like the above-mentioned but in the form of glyceryl esters of the individual fatty acids; glycerol, propylene glycol, ethylene glycol, PEG or sorbitol esters with e.g. vegetable oils like e.g. hydrogenated castor oil, almond oil, palm kernel oil, castor oil, apricot kernel oil, olive oil, peanut oil, hydrogenated palm kernel oil and the like, polyglycerized fatty acids like e.g. polyglycerol stearate, polyglycerol oleate, polyglycerol ricinoleate, polyglycerol linoleate, propylene glycol fatty acid esters such as, e.g. propylene glycol monolaurate, propylene glycol ricinoleate and the like, mono- and di-glycerides like e.g. glyceryl monooleate, glyceryl dioleate, glyceryl mono- and/or di-oleate, glyceryl caprylate, glyceryl caprate etc.; sterol and sterol derivatives; polyethylene glycol sorbitan fatty acid esters (PEG-sorbitan fatty acid esters) such as esters of PEG with the various molecular weights indicated above, and the various Tween series; polyethylene glycol alkyl ethers such as, e.g. PEG oleyl ether and PEG lauryl ether; sugar esters like e.g. sucrose monopalmitate and sucrose monolaurate; polyethylene glycol alkyl phenols like e.g. the Triton X or N series; polyoxyethylene-polyoxypropylene block copolymers such as, e.g., the Pluronic series, the Synperonic series, Emkalyx., Lutrol., Supronic etc. The generic term for these polymers is “poloxamers” and relevant examples in the present context are Poloxamer 105, 108, 122, 123, 124, 181, 182, 183, 184, 185, 188, 212, 215, 217, 231, 234, 235, 237, 238, 282, 284, 288, 331, 333, 334, 335, 338, 401, 402, 403 and 407; sorbitan fatty acid esters like the Span series or Ariacel series such as, e.g. sorbitan monolaurate, sorbitan monopalmitate, sorbitan monooleate, sorbitan monostearate etc.; lower alcohol fatty acid esters like e.g. oleate, isopropyl myristate, isopropyl palmitate etc.; ionic surfactants including cationic, anionic and zwitterionic surfactants such as, e.g. fatty acid salts, bile salts, phospholipids, phosphoric acid esters, carboxylates, sulfates and sulfonates etc. In one specific embodiment the polyethylene glycol surfactant is PEG6000.

The amount of solubilising agent used may vary considerably depending upon the amount of control agent in the core and the like. Nevertheless if a surfactant is used it typically represents from 20% to 80% w/w of the core. In one embodiment the surfactant represents from 40% to 60% w/w of the core. In a specific embodiment the surfactant represents about 50% w/w of the core.

Another feature of the delivery devices of the invention is the presence of a coating enclosing the core of the delivery device that ensures that the control agent is released in the gastrointestinal tract of the target animal species and not in the mouth. Ensuring that the control agent is not released in the mouth is desirable as it means that there is no release of the control agent in the mouth of a non-target animal species prior to their rejection of the delivery device. It also minimises the possibility of the target animal species rejecting part of the dose (due to, by way of example, taste impalatability) and thus a minimal dose of the control agent can be used, minimising potentially adverse environmental effects through use of a minimum dose and also providing for greater selectivity where dose rate (mass of control agent per unit mass of body weight) varies with species.

Accordingly the coating is selected to provide exposure of the core in the preferred region of the gastrointestinal tract of the target animal species. In one embodiment the coating is selected to provide rapid exposure of the core in the preferred region of the gastrointestinal tract of the target animal species. In general this may be readily achieved by selection of the appropriate coating that will dissolve under the pH conditions of the desired location of the gastrointestinal tract and/or after a given residence time in the gastrointestinal tract. In one embodiment the coating provides rapid exposure of the core in the stomach of the target species. This is typically achieved by selection of a coating that will dissolve in the acidic environment of the gastric fluid in the stomach, i.e. at a pH of less than 5.0. An example of a suitable coating is Eudragit® E100.

Further examples of coating materials suitable for use according to the invention include:
acrylate polymers and co-polymers, such as methacrylic acid copolymers Eudragit® S 100, Eudragit® L 100-55, Eudragit® RS PO, Eudragit® RL PO; Eudragit® L 30D;
polyesters, such as the polylactide-co-glycolide polymers and polyhydroxybutyrate-co-valerate polymers;
polysaccharides, such as, hydroxypropyl cellulose, ethyl cellulose, cellulose acetate, cellulose acetate butyrate, cellulose acetate phthalate, hydroxypropyl methyl cellulose acetate succinate, cellulose acetate trimellitate, hydroxypropyl methyl cellulose phthalate (HP-55), hydroxypropyl methyl cellulose (TC-5), microcrystalline cellulose/pre-gelatinised starch, shellac, etc.;
polyamides
cyclodextrins;
alginates;
poly(amino acids);
poly(ortho esters);
polyanhydrides;
polyphosphoesters;
polymers formed through combinations of chemical bonds (such as pseudo-peptides, poly(phosphoester-urethanes) and polydepsipeptides);
polyethylene oxide;
polyvinyl acetate phthalate;
   and/or polymer blends such as:
Klucel EF mixed with Methocel K4M and lecithin;
polyethylene glycol (PEG)/acrylic resins/Et cellulose blends;
cyclodextrin blended with polyglycolized glycerides;
hydroxypropylmethylcellulose/hydroxypropylcellulose;
Eudispert HV/glycerine admixtures;
cellulose ether/wax blends;
Kraton G (styrene block copolymer) with hydrocarbon wax's and Super Resin HC 140 (hydrocarbon resin);
ethylcellulose/isomalt/PVP K30/hydrogenated castor oil;
hydroxyalkylcellulose/PVP;
N-vinylpyrollidone/vinyl acetate copolymer (e.g. Plasdone S-630);
hydroxypropyl methylcellulose and xanthan gum; and
   other suitable materials which could be used, the nature of which would be apparent to those skilled in the art.

The coating of the delivery device may contain one or more additives that may aid in the performance of the delivery device. For example, it may be found that it is desirable that the coating be formulated in order to ensure ease of processing or to increase hardness. In order to aid processing or increase the hardness of the coating matrix it may be necessary to incorporate additional components. This is typically achieved by selection of additional components that might include:
phthalates (e.g. diethyl phthalate, butylbenzyl phthalate ester, [85-68-7], dibutyl phthalate, [84-74-2], dibutyl phthalate ester, [84-74-2], dibutyl phthalate ester, [84-74-2], diethyl phthalate ester, [84-66-2], dihexyl phthalate ester, [84-75-3], diisoheptyl phthalate ester, [84-61-7], diisononyl phthalate ester, [28553-12-0], dioctyl phthalate ester, [117-81-7];
phthalate esters (e.g. diethyl [CAS # 84-66-2], dibutyl [CAS # 84-74-2], dioctyl [CAS # 117-81-7], diisononyl [CAS # 28553-12-0], butyl benzyl [CAS # 85-68-7], dihexyl [CAS # 84-75-3], diisoheptyl [CAS # 84-61-7]);
esters (glyceryl triacetate, triethyl citrate, acetyl triethyl citrate, dibutyl oleate, dibutyl adipate, [105-99-7], dibutyl sebacate, [109-43-3], dibutyl ax(z)elate, [2917-73-9], saccharose acetate isobutyrate, [126-13-6]);
phosphate esters (e.g. tributyl [CAS # 126-73-8], trioctyl [CAS # 78-42-2], cresyl diphenyl [CAS # 26444-49-5], triphenyl [CAS # 115-86-6]), cresyldiphenyl phosphate ester, [26444-49-5];
adipates (i.e. dibutyl [CAS # 105-99-7]), axelates (dibutyl [CAS # 2917-73-9]), oleates, and sebacates (dimethyl, dibutyl, dioctyl);
epoxylated materials (e.g. oxidized vegetable oils and fatty acids);
fatty acid esters (e.g. esterified fatty acids, glycerol [CAS # 56-81-5], and alky ester and their analogues thereof);
glycol derivatives (e.g. esters, e.g. 1,3-butylene glycol [CAS # 2517-43-3], polyethylene glycol [CAS # 25322-68-3], polypropylene glycol 1,3-butylene glycol [CAS # 2163-42-0], film forming agents generally, glycerine [CAS # 56-81-5]);
polyhydric alcohols (glycols) (e.g. propylene glycols, polyethylene glycols, glycerol, stearyl alcohol, [112-92-5]);
citrates (e.g. triethyl [CAS # 77-93-0])
polyoxyethylene sorbitan oleate laureate (fatty acid esters) [CAS # 37232-02-3];
sulphonamides;
glycerides and acetylated monoglycerides
hydrocarbons;
n-alkylbenzenes (C₆H₅(CnH₍₂ₙ₊₁₎) (e.g. n=3-10); and
   other suitable materials which could be used, the nature of which would be apparent to those skilled in the art.

The invention also relates to the use of the delivery devices described above in baiting of selected target animal species. The invention thus provides a method of controlling a target animal species in an environment containing the target animal species, the method including laying a bait in the environment, the bait including:

(i) a delivery device including:
(a) a core containing a control agent for the target animal species;
   and
(b) an impermeable coating enclosing the core, the coating being selected to provide exposure of the core in the gastrointestinal tract of the target animal species;
   wherein the coating of the delivery device has a hardness such that the coating is not readily breached upon mastication by a target or non-target animal species and further wherein the delivery device will not pass through a Tyler 5 mesh; and
   (ii) an attractant.

The bait that is laid may take any of a wide variety of forms well known in the art. In general, however, the bait is configured such that the attractant is located around the delivery device. Any suitable attractant may be used that will entice the target species to consume the bait. In one embodiment the attractant for a carnivore is meat or a meat based product.

The baits may be laid in any way known in the art. They may be laid manually in which case they are placed in the desired location by the person applying the baits to the environment containing the target species. Alternatively, in many instances it is more economical to lay the baits aerially in which case they are dropped from an aircraft as it travels over the environment containing the target species. The baits may be laid in any suitable concentration although typically they are laid in the environment at from 10 to 1000 baits per square kilometre. In one embodiment the baits are laid in the environment at from 30 to 70 baits per square kilometre. In another embodiment the baits are laid in the environment at about 50 baits per square kilometre. In a further embodiment of the method of the invention the delivery device used in the invention contains the features of the delivery devices described above.

### Manufacture of the Delivery Devices

### Preparation of Delivery Devices

Delivery devices containing p-aminopropiophenone (“PAPP”) formulation were made as follows. PAPP tablets weighing 135 mg were coated using a plastic extrusion apparatus into which Eudragit® E100 had been melt processed, so as to form individual coated tablets, of approximately 12 mm length and 6.5 mm diameter.

A procedure for the coating of materials that finds particular application in the manufacture of the delivery devices of the present invention has been reported (PCT/AU97/00872). The apparatus and methods use ‘melt processing’ to prepare the coating and coat the ‘drug core’. The apparatus and methods have necessarily been modified to enable production of the particular delivery devices of the present invention (macrocapsules, up to or greater than 4 mm in diameter and length) consisting of a ‘control agent-core’ formulation, coated with (and sealed inside of) layers of an impermeable coating selected from the range of coating materials (polymers, copolymers and polymer blends listed above).

The basis of the production method is as follows:
a drug formulation (or “drug-core”) is inserted into (surrounded by) an impermeable coating structure;
the impermeable coating is a dispersible/dissolvable matrix;
the manner of manufacture enables coating of the ‘drug-core’ with a coating matrix of known, reproducible and controllable physico-chemical attributes; and
the dispersion/dissolution kinetics of the coating are both predictable and controllable as a result of the coating formulation attributes and the manner of manufacture of the coating structure.
   Delivery devices containing PAPP formulations (coated ‘drug-cores’ or Hard Shell Delivery Vehicles (“HSDV”)) were prepared as follows:
solid-dose drug-cores were prepared by known methods, such as but not limited to, routine tableting methods;
the coating materials processor/formulator was prepared for operation, including equilibrating of zone temperatures as required;
delivery device coating material was loaded into the feed hopper as required (material processor ‘screw(s)’ operating);
air cooling for the coating material (extrudate) set as required;
when the extrudate was considered to be at equilibrium, (i) the ‘drug-core’ injector, and (ii) the sealing/crimping unit were activated and ‘drug-doses’ were automatically inserted into the hollow of the extrudate at appropriate intervals;
the extrudate was sealed between each inserted ‘drug-dose’ by passage of the extrudate with the ‘drug-core’ in situ into the sealing/crimping tool immediately upon its exit from the extruder;
the continuous extrudate (‘sealed/coated drug-cores’) was air cooled as required; and
individual coated ‘drug-cores’ (HSDV's) were prepared by ‘snapping’ or by cutting at the midway point of the seal between doses using, by way of example, a hot wire.
   Table 3 presents the conditions typically used for preparation and application of the coating formulation blends based on Eudragit® E100.

TABLE 3
Melt Coating Conditions

| | | | Zone Temperatures | | | | |
|---|---|---|---|---|---|---|---|
| ‘Coating’ | Proc- | | (° C.) | | | | |
| Formulation | essor | ID | 1 | 2 | 3 | Die | rpm |
| E100 | XJ13 | 4725 | 40 | 120 | 120 | 110 | 10 |
| E100 | XJ13 | 1500, | 110 | 150 | 150 | 130 | 20 |
| | | 1501 | | | | | |
| E100 | XJ13 | 1503 | 90 | 120 | 120 | 110 | 16 |
| E100 | XJ13 | 1504 | 90 | 120 | 120 | 110 | 10 |
| E100 | XJ13 | 1505 | 90 | 120 | 120 | 110 | 15 |
| E100 | XJ13 | 1506, | 90 | 120 | 120 | 110 | 10 |
| | | 1507 | | | | | |
| E100 | XJ13 | 1508, | 90 | 120 | 120 | 110 | 12 |
| | | 1509, | | | | | |
| | | 1510, | | | | | |
| | | 1511 | | | | | |
| E-100 + 5% Dibutyl | XJ13 | 1502 | 85 | 120 | 120 | 110 | ~12 |
| Sebacate | | | | | | | |
| E-100 + 5% GMS | XJ13 | 1513 | 90 | 120 | 140 | 115 | 12 |
| E-100 + 5% GMS + | XJ13 | 1514 | 95 | 115 | 110 | 100 | ~12 |
| 5% Span 65 | | | | | | | |
| E-100 + 5% | XJ13 | 1515 | 90 | 110 | 110 | 110 | ~12 |
| Span 65 | | | | | | | |
| E-100 + 10% Teric | XJ13 | 1520 | 80 | 95 | 95 | 90 | 12 |
| SF15 | | | | | | | |
| E-100 + 10% | XJ13 | 1522 | 80 | 95 | 95 | 90 | 12 |
| Stearic Acid | | | | | | | |
| E-100 + 10% | XJ13 | 1524 | 70 | 90 | 95 | 90 | 14 |
| Stearyl Alcohol | | | | | | | |
| E-100 + 10% | XJ13 | 1525 | 90 | 90 | 95 | 90 | 14 |
| Stearyl Alcohol | | | | | | | |
| E-100 + 10% | XJ13 | 1526 | 60 | 80 | 80 | 80 | 25 |
| Stearyl Alcohol | | | | | | | |
| E-100 + 10% | XJ13 | 1527 | 60 | 85 | 85 | 85 | 18 |
| Tristearin | | | | | | | |
| E-100 + 10% 1- | XJ13 | 1528 | 60 | 85 | 90 | 90 | 30 |
| Hexadecanol | | | | | | | |
| E-100 + 10% 1- | XJ13 | 1528 | ~60 | ~85 | ~90 | ~90 | ~20 |
| Hexadecanol | | | | | | | |
| E-100 + 10% | XJ13 | 1529 | 65 | 85 | 90 | 90 | 16 |
| Arlacel 60 | | | | | | | |
| E-100 + 10% | XJ13 | 1530 | 65 | 85 | 90 | 90 | 16 |
| Tween | | | | | | | |
| E-100 + 5% | XJ8 | 1516 | 110 | 110 | — | — | 20 |
| Span 65 | | | | | | | |
| E-100 + 25% | XJ8 | 1517 | 110 | 110 | — | — | 20 |
| Span 65 | | | | | | | |

The process will now be outlined by reference to the following examples:

### EXAMPLES

### Example 1

### Manufacture of Delivery Devices

Following the general manufacturing procedure described above and by varying the components used in the core the delivery devices detailed in Table 4 were produced.

TABLE 4
Delivery Devices of the Invention

| | | | | Device size |
|---|---|---|---|---|
| | | | Core:Coating | (mm) |
| Coating | Core | ID | Ratio | (ø × length) |
| E100 | PAPP•HCl 50 parts | 4725 | ~50:50 | 4.5 × 10.6 |
| | PEG6000 50 parts | | | |
| E100 | PAPP•HCl 50 parts | 4726 | ~50:50 | 4.5 × 11.0 |
| | Vitamin E 50 parts | | | |
| E100 | PAPP•HCl 50 parts | 4727 | ~50:50 | 4.5 × 10.9 |
| | PEG6000 25 parts | | | |
| | Vitamin E 25 parts | | | |
| E100 | PAPP•HCl 50 parts | 4728 | ~50:50 | 4.5 × 11.1 |
| | PEG6000 25 parts | | | |
| | Sanwet 25 parts | | | |
| E100 | PAPP•HCl 50 parts | 1500, 1501 | 45:55 | 4.5 × 11.0 |
| | PEG6000 50 parts | | | |
| E100 | PAPP•HCl 50 parts | 1503 | 45:55 | 4.5 × 11.0 |
| | PEG6000 50 parts | | | |
| E100 | PAPP•HCl 50 parts | 1504 | 45:55 | 4.5 × 11.0 |
| | PEG6000 50 parts | | | |
| E100 | PAPP•HCl 50 parts | 1505 | 45:55 | 4.5 × 11.0 |
| | PEG6000 50 parts | | | |
| E100 | PAPP•HCl 50 parts | 1506, 1507 | 45:55 | 4.5 × 11.0 |
| | PEG6000 50 parts | | | |
| E100 | PAPP•HCl 50 parts | 1508, | 40:60 | 6.0 × 12.0 & |
| | PEG6000 50 parts | 1509, | | 6.5 × 8.0 |
| | | 1510, 1511 | | |
| E-100 + 5% Dibutyl | PAPP•HCl 50 parts | 1502 | 45:55 | 4.5 × 11.0 |
| Sebacate | PEG6000 50 parts | | | |
| E-100 + 5% GMS | PAPP•HCl 50 parts | 1513 | 45:55 | 4.5 × 11.0 |
| | PEG6000 50 parts | | | |
| E-100 + 5% GMS + | PAPP•HCl 50 parts | 1514 | 45:55 | 5.0 × 9.0 |
| 5% Span 65 | PEG6000 50 parts | | | |
| E-100 + 5% Span 65 | PAPP•HCl 50 parts | 1515 | 45:55 | 6.5 × 8.0 |
| | PEG6000 50 parts | | | |
| E-100 + 10% Teric | PAPP•HCl 50 parts | 1520 | 40:60 | 6.5 × 8.0 |
| SF15 | PEG6000 50 parts | | | |
| E-100 + 10% Stearic | PAPP•HCl 50 parts | 1522 | ~45:55 | 6.5 × 8.0 |
| Acid | PEG6000 50 parts | | | |
| E-100 + 10% Stearyl | PAPP•HCl 50 parts | 1524 | ~45:55 | ~6.5 × 8.5 |
| Alcohol | PEG6000 50 parts | | | |
| E-100 + 10% Stearyl | PAPP•HCl 50 parts | 1525 | ~45:55 | 5.0 × 9.0 |
| Alcohol | PEG6000 50 parts | | | |
| E-100 + 10% Stearyl | PAPP•HCl 50 parts | 1526 | ~50:50 | 6.5 × 8.0 |
| Alcohol | PEG6000 50 parts | | | |
| E-100 + 10% | PAPP•HCl 50 parts | 1527 | ~45:55 | 5.0 × 9.0 |
| Tristearin | PEG6000 50 parts | | | |
| E-100 + 10% 1- | PAPP•HCl 50 parts | 1528 | 60:40 | 6.5 × 15.0 |
| Hexadecanol | PEG6000 50 parts | | | |
| E-100 + 10% Arlacel | PAPP•HCl 50 parts | 1529 | ~45:55 | 5.0 × 9.0 |
| 60 | PEG6000 50 parts | | | |
| E-100 + 10% Tween | PAPP•HCl 50 parts | 1530 | 45:55 | 6.5 × 12.0 |
| | PEG6000 50 parts | | | |

Selected samples of the above coating formulations were analysed to determine their Shore D hardness using ASTM D 2240, Shore D. Samples were tested at 23° C. at a relative humidity of 50%. By way of example, the average thickness of sample 1 was 7.94 mm. The average thickness of sample 2 was 8.29 mm. The test results were as follows:

### Sample 1 (Run ID=4725)

Average Shore D hardness=70.2

### Standard Deviation=1.5

### Sample 2 (Run ID=1500)

Average Shore D hardness=71.2

### Standard Deviation=1.3

Samples from certain of the above production runs were analysed to determine a Point Pressure Failure value using an in-house Test Method (# Sci742). The purpose of this test is to gauge the force required to cause structural failure of a test sample when a force is applied through a point of known dimensions. The test pin tip is round with the point being a semicircle of defined radius, e.g. pin PP0.5 having a point radius=0.5 mm.

The pin is used to induce failure of the coating matrix of the HSDV (cracking, rupturing, chipping and/or puncture), with the force applied being a result of a mass loaded onto the test pin, the mass load being measured using a modified electronic balance.

The test method entails:
1. Measuring the dimensions of each specimen (e.g. length, width, diameter) with a micrometer calliper to the nearest 0.25 mm;
2. Checking the specimens for conformity in the region to be tested;
3. The sample to be tested being positioned on a balance with a flat solid surface. The sample under test may be held (supported) within a specimen holder to stop lateral movement of the sample during the testing procedure;
4. The point of the test pin is located directly above the region of the specimen to be tested;
5. The voltage reference circuit is reset to zero;
6. The balance is set to zero;
7. The point of the test pin is placed in contact with the sample (region) to be tested without applying any force; and
8. A force is applied to the top of the test pin, with it gradually being increased until the sample under test fails.
   Failure is defined as any structural damage which could compromise the function of the coating. Such failure includes cracking, rupturing, chipping and/or puncture. The Test Method requires that the type of failure (for each specimen) be recorded as one of the five (5) coded categories defined as follows:
   F a break in which the coating fractures or cracks, whether at the point of application of the force or elsewhere, without breaking into (two or more) pieces.
   R complete break, or rupture, in which the coating breaks into (two or more) pieces as a result of application of the force, whether at the point of application of the force or elsewhere.
   CH wherein a segment of the coating fragments or chips away from the coating structure at the point of application of the force without the coating breaking.
   P wherein the pin penetrates the coating at the point of application of the force without the coating breaking, chipping or fracturing.
   NB non-break or complete failure to damage the coating (out of range of the test procedure).
   Table 5 presents data typically obtained for samples prepared using coating formulation blends based on Eudragit® E100. In order to probe the suitability of the coating hardness without needing to work with the toxicant formulation, a number of samples were prepared incorporating cores composed of a lactose/Rhodamine B blend (“Lac R”).

TABLE 5
Point Pressure Failure

| | | | | Samples | | | |
|---|---|---|---|---|---|---|---|
| ‘Coating’ | | Wall | | Tested | | Mass | Failure |
| Formulation | ID | Thickness (mm) | Core | (#) | mV | (g) | Mode |
| E100 | 1509 | 0.50 | PEG | 5 | 649 | 1117.92 | 3R, 2F |
| E100 | 1510 | 0.50 | Lac R | 5 | 938 | 1615.24 | 4R, F |
| E-100 + 5% | 1513 | 0.50 | Lac R | 2 | 473 | 814.51 | 2R |
| GMS | | | | | | | |
| E-100 + 5% | 1515 | 0.40 | Lac R | 4 | 1177 | 2026.36 | 3R, F |
| Span 65 | | | | | | | |
| E-100 + 5% | 1515 | 0.60 | Lac R | 6 | 1339 | 2306.05 | 6R |
| Span 65 | | | | | | | |
| E-100 + 10% | 1520 | 0.80 | Lac R | 5 | 1152 | 1983.40 | 5P |
| Teric SF15 | | | | | | | |
| E-100 + 10% | 1522 | 0.50 | Lac R | 15 | 1105 | 1902.24 | 15P |
| Stearic Acid | | | | | | | |
| E-100 + 10% | 1524 | 0.25 | PEG | 4 | 779 | 1341.87 | 4P |
| Stearyl Alcohol | | | | | | | |
| E-100 + 10% | 1524 | 0.50 | Lac R | 5 | 887 | 1527.41 | R, 4P |
| Stearyl Alcohol | | | | | | | |
| E-100 + 10% | 1526 | 0.50 | Lac R | 4 | 1294 | 2227.84 | F, 3P |
| Stearyl Alcohol | | | | | | | |
| E-100 + 10% | 1526 | 0.25 | Lac R | 2 | 1992 | 3430.22 | 2R |
| Stearyl Alcohol | | | | | | | |
| E-100 + 10% | 1528 | 0.40 | Lac R | 5 | 2415 | 4158.63 | 5R |
| 1-Hexadecanol | | | | | | | |
| E-100 + 10% | 1530 | 0.50 | Lac R | 5 | 1060 | 1824.63 | 2R, F, |
| Tween | | | | | | | 2P |
| E-100 + 10% | 1530 | 0.50 | PEG | 7 | 1510 | 2600.96 | 3F, 4P |
| Tween | | | | | | | |

### Example 2

### Determination of Required Device Size

In order to determine the appropriate device size to provide some selectivity between a target and a non-target species, studies were carried out using solid bearings and/or Lac R tablets. Specifically, studies to determine the propensity of cats (as a target species) and several typical non-target species to ingest large particles were undertaken.

The feral cat studies entailed presenting subjects with spherical bearings up to 4.7 mm in diameter contained within the ‘bait’ attractant medium. The presence of the bearings did not affect bait consumption by the target species relative to untreated baits. Repetitive ingestion was highly reliable in the first 9 days of a feeding trial and diminished only marginally in a consecutive trial.

In respect of non-target species, captive plains rats (Pseudomys australis), fat-tailed dunnarts (Sminthopsis crassicaudata), eastern barred-bandicoots (Perameles gunnii), and northern quolls (Dasyurus hallucatus), were presented with baits containing 4.7 mm diameter coated pellets formulated with the marker dye Rhodamine B (“RB”). Exposure to the RB for each species was not biased to individual or day of presentation. Exposure to RB in the pellet occurred in only 3.1-6.5% of presentations for each species, and the mean daily mass of the pellet in g kg⁻¹ day⁻¹ ingested was 0.078-0.01% of the mean bait mass in g kg⁻¹ day⁻¹ consumed. Pellet presentation greatly reduced (P≦0.001) the exposure of wild native rodents to RB relative to directly injected baits.

These outcomes demonstrated that there was differential particle size ingestion between target subjects (feral cats) and non-target (native) species which would reduce exposure of the non-target mammals to control agent(s) and decrease the risk of baiting to non-target species. This indicated that the device should be such that it did not pass through a Tyler 5 mesh, preferably a Tyler 4 mesh.

### Example 3

### Toxicant Efficacy Studies—Felids

The in vivo testing was conducted in two ways. The procedure entailed either low level anaesthetising of subjects, followed by oesophageal administration of a formulation dose of the control agent (p-aminopropiophenone), or voluntary consumption of a ‘bait’ containing a dose of the control agent.

Where undertaken, methaemoglobin (“MetHb”) levels were monitored using a Radiometer Pacific OSM-3 Haemoximeter. Raw data generated from these in vivo studies were analysed and the statistical results are presented in tabular form in Tables 6 & 7. Statistical Analysis of the Data was undertaken using the Microsoft Excel (V5.0) Statistical Package. Statistical data presented include (i) the number of samples evaluated (n), and (ii) the group mean [and the standard deviation (stdevp)] for the time to achieve (a) 10% MetHb (“t_{10%}”), (b) 50% MetHb (“t_{50%}”), (c) 70% MetHb (“t_{70%}”), (d) 85% MetHb (“t_{85%}”), (e) the time to traverse from 10 to 70% MetHb (“t_{(70-10%)}”), (f) the maximum % MetHb achieved (“MetHb_{(% max)}”), (g) the rate of MetHb induction (“rₘₐₓ”) (% min⁻¹), and (h) dose administered (in mg kg⁻¹).

TABLE 6
Naked Dose Efficacy (‘naked’ formulations = core only administered)

| Formulation (#) | | |
|---|---|---|
| Mean mass [stdevp] (mg PAPP kg⁻¹) | | Mean Time [stdevp] (min) |
| (y subjects tested) | | (x of y subjects tested) |
| % stdevp of the mean mass | Milestone | % stdevp of the mean time |
| Reference Formulations - DMSO | 85% MetHb | 75 [24] (9 of 17) 32% |
| Dose administered = 8 [3] | 70% MetHb | 55 [20] (16 of 17) 36% |
| (mg PAPP kg⁻¹) | 50% MetHb | 35 [12] (17 of 17) 34% |
| (n = 17) 36% | 10% MetHb | 10 [5] (17 of 17) 50% |
| | t_{(70-10%)} (min) | 45 [17] (16 of 17) 37% |
| | MetHb_{(% max)} | 80 [7] (17 of 17) 9% |
| | rₘₐₓ(% min⁻¹) | — |
| Reference Formulation - “Feracon” | 85% MetHb | 101 [27] (4 of 5) 26% |
| Dose administered = 12 [3] | 70% MetHb | 39 [6] (4 of 5) 16% |
| (mg PAPP kg⁻¹) | 50% MetHb | 25 [5] (4 of 5) 19% |
| (n = 5) 24% | 10% MetHb | 10 [2] (4 of 5) 24% |
| | t_{(70-10%)} (min) | 29 [4] (4 of 5) 14% |
| | MetHb_{(% max)} | 86 [2] (4 of 5) 2% |
| | rₘₐₓ(% min⁻¹) | — |
| PAPP:PEG6000 (50:50) | 85% MetHb | 62 [12] (3 of 6) 20% |
| #'s 4660 & 4664 | 70% MetHb | 64 [28] (6 of 6) 44% |
| Dose administered = 15 [3] | 50% MetHb | 45 [20] (6 of 6) 45% |
| (mg PAPP kg⁻¹) | 10% MetHb | 24 [13] (6 of 6) 56% |
| (n = 6) 19% | t_{(70-10%)} (min) | 40 [19] (6 of 6) 47% |
| | MetHb_{(% max)} | 86 [2] (6 of 6) 2% |
| | rₘₐₓ(% min⁻¹) | — |
| PAPP:Lactose (50:50) | 85% MetHb | 101 [49] (4 of 5) 48% |
| #'s 4659 & 4663 | 70% MetHb | 95 [48] (5 of 5) 51% |
| Dose administered = 18 [4] | 50% MetHb | 79 [43] (5 of 5) 54% |
| (mg PAPP kg⁻¹) | 10% MetHb | 48 [30] (5 of 5) 62% |
| (n = 5) 24% | t_{(70-10%)} (min) | 47 [25] (5 of 5) 54% |
| | MetHb_{(% max)} | 86 [5] (5 of 5) 5% |
| | rₘₐₓ(% min⁻¹) | — |
| PAPP•HCl:PEG6000 (50:50) | 85% MetHb | 63 [24] (15 of 15) 38% |
| #'s 4662, 4666 & 4668 | 70% MetHb | 37 [12] (15 of 15) 31% |
| Dose administered = 17 [6] | 50% MetHb | 24 [6] (15 of 15) 25% |
| (mg PAPP•HCl kg⁻¹) | 10% MetHb | 7 [3] (15 of 15) 35% |
| (n = 15) 37% | t_{(70-10%)} (min) | 30 [10] (15 of 15) 33% |
| | MetHb_{(% max)} | 86 [3] (15 of 15) 3% |
| | rₘₐₓ(% min⁻¹) | — |
| PAPP•HCl:Lactose (50:50) | 85% MetHb | — [—] (0 of 5) —% |
| #'s 4661 & 4665 | 70% MetHb | 79 [28] (5 of 5) 37% |
| Dose administered = 16 [4] | 50% MetHb | 44 [17] (5 of 5) 38% |
| (mg PAPP•HCl kg⁻¹) | 10% MetHb | 17 [7] (5 of 5) 40% |
| (n = 5) 22% | t_{(70-10%)} (min) | 62 [2] (5 of 5) 40% |
| | MetHb_{(% max)} | 77 [3] (5 of 5) 4% |
| | rₘₐₓ(% min⁻¹) | — |
| PAPP•HCl:Vitamin E (50:50) | 85% MetHb | 75 [8] (6 of 6) 11% |
| Formulation # 4669 | 70% MetHb | 40 [9] (6 of 6) 24% |
| Dose administered = 18 [2] | 50% MetHb | 27 [7] (6 of 6) 27% |
| (mg PAPP•HCl kg⁻¹) | 10% MetHb | 8 [3] (6 of 6) 40% |
| (n = 6) 11% | t_{(70-10%)} (min) | 32 [7] (6 of 6) 21% |
| | MetHb_{(% max)} | 87 [2] (6 of 6) 4% |
| | rₘₐₓ(% min⁻¹) | — |
| PAPP•HCl:Vitamin E:PEG6000 (50:25:25) | 85% MetHb | 47 [17] (4 of 6) 37% |
| # 4672 | 70% MetHb | 33 [9] (6 of 6) 27% |
| Dose administered = 16 [4] | 50% MetHb | 22 [6] (6 of 6) 27% |
| (mg PAPP•HCl kg⁻¹) | 10% MetHb | 8 [5] (6 of 6) 61% |
| (n = 6) 22% | t_{(70-10%)} (min) | 25 [6] (6 of 6) 25% |
| | MetHb_{(% max)} | 84 [3] (6 of 6) 4% |
| | rₘₐₓ(% min⁻¹) | — |
| PAPP•HCl:PEG6000:Sanwet ® (50:25:25) | 85% MetHb | 61 [16] (3 of 3) 26% |
| # 4675 | 70% MetHb | 42 [13] (3 of 3) 30% |
| Dose administered = 19 [7] | 50% MetHb | 43 [17] (3 of 3) 40% |
| (mg PAPP•HCl kg⁻¹) | 10% MetHb | 12 [7] (3 of 3) 58% |
| (n = 3) 35% | t_{(70-10%)} (min) | 30 [6] (3 of 3) 19% |
| | MetHb_{(% max)} | 87 [1] (3 of 3) 1% |
| | rₘₐₓ(% min⁻¹) | — |
| PAPP•HCl:PEG20,000 (50:50) | 85% MetHb | 50 [2] (5 of 5) 4% |
| # 4677 | 70% MetHb | 28 [5] (5 of 5) 19% |
| Dose administered = 21 [9] | 50% MetHb | 18 [3] (5 of 5) 18% |
| (mg PAPP•HCl kg⁻¹) | 10% MetHb | 4 [1] (5 of 5) 22% |
| (n = 5) 41% | t_{(70-10%)} (min) | 25 [5] (5 of 5) 20% |
| | MetHb_{(% max)} | 86 [1] (5 of 5) 1% |
| | rₘₐₓ(% min⁻¹) | — |
| PAPP•HCl:PEG6000:Explotab ® (50:25:25) | 85% MetHb | 78 [12] (2 of 2) 15% |
| # 4684 | 70% MetHb | 55 [15] (2 of 2) 27% |
| Dose administered = 13 [4] | 50% MetHb | 43 [15] (2 of 2) 34% |
| (mg PAPP•HCl kg⁻¹) | 10% MetHb | 12 [6] (2 of 2) 48% |
| (n = 2) 28% | t_{(70-10%)} (min) | 43 [9] (2 of 2) 21% |
| | MetHb_{(% max)} | 86 [1] (2 of 2) 1% |
| | rₘₐₓ(% min⁻¹) | — |
| PAPP•HCl:PEG1500 (50:50) | 85% MetHb | 46 [—] (1 of 3) —% |
| # 4676 | 70% MetHb | 30 [12] (3 of 3) 40% |
| Dose administered = 15 [4] | 50% MetHb | 19 [8] (3 of 3) 39% |
| (mg PAPP•HCl kg⁻¹) | 10% MetHb | 5 [3] (3 of 3) 48% |
| (n = 3) 23% | t_{(70-10%)} (min) | 25 [10] (3 of 3) 39% |
| | MetHb_{(% max)} | 81 [3] (3 of 3) 4% |
| | rₘₐₓ(% min⁻¹) | — |
| PAPP•HCl:PEG6000:Triethyl citrate (“Tec”) | 85% MetHb | 40 [—] (1 of 3) —% |
| (50:40:10) | 70% MetHb | 69 [48] (3 of 3) 69% |
| # 4681 | 50% MetHb | 28 [11] (3 of 3) 38% |
| Dose administered = 23 [6] | 10% MetHb | 9 [6] (3 of 3) 64% |
| (mg PAPP•HCl kg⁻¹) | t_{(70-10%)} (min) | 60 [42] (3 of 3) 70% |
| (n = 3) 25% | MetHb_{(% max)} | 81 [5] (3 of 3) 6% |
| | rₘₐₓ(% min⁻¹) | — |
| PAPP•HCl:PEG6000:Propylene glycol (“PG”) | 85% MetHb | 60 [—] (1 of 4) —% |
| (50:40:10) | 70% MetHb | 38 [12] (4 of 4) 32% |
| # 4679 | 50% MetHb | 18 [6] (4 of 4) 33% |
| Dose administered = 25 [4] | 10% MetHb | 4 [2] (4 of 4) 35% |
| (mg PAPP•HCl kg⁻¹) | t_{(70-10%)} (min) | 34 [11] (4 of 4) 32% |
| (n = 4) 15% | MetHb_{(% max)} | 76 [5] (4 of 4) 6% |
| | rₘₐₓ(% min⁻¹) | — |

The data presented in Table 6 demonstrate that:
(i) the formulations evaluated delivered PAPP in a manner adequate to induce production of MetHb at levels near to or greater than the target 85% threshold;
(ii) there were differential formulation attributes which correlate with formulation performance (dispersion of, and uptake there from), i.e. differences in rate and extent of absorption of the dose-form were directly attributable to matrix composition;
(iii) there was, generally, consistency of repeatability at the different performance milestones; and
(iv) there was generally good reproducibility of performance.
   In respect to the differential effects of excipient type and loading, the data generally suggest that surfactant based formulations provide (i) more rapid availability (dispersion/solubilisation), (ii) faster uptake (absorption) of the active, and (iii) greater efficacy.

TABLE 7
Coated Dose (HSDV) Efficacy

| Formulation (#) | | |
|---|---|---|
| Mean mass [stdevp] (mg PAPP kg⁻¹) | | Mean Time [stdevp] (min) |
| (y subjects tested) | | (x of y subjects tested) |
| % stdevp of the mean mass | Milestone | % stdevp of the mean time |
| E100 {PAPP•HCl:P6 (50:50)} | 85% MetHb | 178 [27] (5 of 6) 15% |
| # 4725 | 70% MetHb | 144 [31] (5 of 6) 21% |
| Dose administered = 27 [7] | 50% MetHb | 130 [33] (5 of 6) 25% |
| (mg PAPP•HCl kg⁻¹) | 10% MetHb | 108 [32] (5 of 6) 29% |
| (n = 6) 24% | t_{(70-10%)} (min) | 36 [5] (5 of 6) 13% |
| | MetHb_{(% max)} | 88 [2] (5 of 6) 3% |
| | rₘₐₓ(% min⁻¹) | 1.25 [0.25] (5 of 6) 19% |
| E100 {PAPP•HCl:Vₑ (50:50)} | 85% MetHb | 276 [177] (2 of 9) 64% |
| # 4726 | 70% MetHb | 240 [106] (6 of 9) 44% |
| Dose administered = 16 [4] | 50% MetHb | 225 [102] (7 of 9) 45% |
| (mg PAPP•HCl kg⁻¹) | 10% MetHb | 146 [77] (8 of 9) 53% |
| (n = 9) 20% | t_{(70-10%)} (min) | 88 [28] (6 of 9) 32% |
| | MetHb_{(% max)} | 67 [24] (9 of 9) 36% |
| | rₘₐₓ(% min⁻¹) | 0.59 [0.41] (8 of 9) 69% |
| E100 {PAPP•HCl:P6:Vₑ (25:25:50)} | 85% MetHb | 328 [180] (2 of 3) 55% |
| # 4227 | 70% MetHb | 262 [144] (2 of 3) 55% |
| Dose administered = 21 [6] | 50% MetHb | 223 [118] (2 of 3) 53% |
| (mg PAPP•HCl kg⁻¹) | 10% MetHb | 302 [232] (3 of 3) 77% |
| (n = 3) 30% | t_{(70-10%)} (min) | 119 [78] (2 of 3) 66% |
| | MetHb_{(% max)} | 67 [29] (3 of 3) 43% |
| | rₘₐₓ(% min⁻¹) | 0.50 [0.37] (3 of 3) 73% |
| E100 {PAPP•HCl:P6:S_{w} (25:25:50)} | 85% MetHb | 221 [88] (7 of 13) 40% |
| # 4728 | 70% MetHb | 204 [82] (8 of 13) 40% |
| Dose administered = 27 [12] | 50% MetHb | 191 [80] (8 of 13) 40% |
| (mg PAPP•HCl kg⁻¹) | 10% MetHb | 294 [374] (9 of 13) 127% |
| (n = 13) 44% | | (164 [77] (8 of 13) 47%) |
| | t_{(70-10%)} (min) | 40 [20] (8 of 13) 51% |
| | MetHb_{(% max)} | 77 [24] (9 of 13) 31% |
| | rₘₐₓ(% min⁻¹) | 1.41 [0.49] (8 of 13) 35% |

From the data presented in Table 7 it is apparent that:
MetHb induction was achieved following PAPP administration as a HSDV formulation, i.e. demonstrating unequivocally that the HSDV formulations evaluated dispersed, enabling dissolution/absorption of the encased control agent formulation, affording efficacy from the control agent;
there were differential formulation attributes which appear to favour dispersion of, and absorption from, certain of the HSDV formulations;
the ‘performance’ profiles were, subject to an anticipated variability in initiation of dispersion/absorption of the control agent from the HSDV, comparable to those for the equivalent ‘naked’ dose formulations (Table 6); and
reproducibility and repeatability were satisfactory in light of understood uncertainties pertaining to the in vivo testing protocol.

### Example 4

### Delivery Device—‘Bait’ Formulations

49 experiments entailing presentation of a delivery device (HSDV) dose contained within the attractant component of the ‘bait’ to an unrestrained conscious subject have been completed. Table 8 presents a summary of the data generated from these tests. All subjects had (i) consumed the bait freely, (ii) exhibited 1^{st} definitive symptoms at or about 75 minutes after consumption of the bait, and (iii) exhibited a peak in symptoms, i.e. an appropriate peak [MetHb], approximately 100-200 minutes after consumption of the bait.

The experiments entailing voluntary consumption of a ‘bait’ containing a dose of the control agent (p-aminopropiophenone) were carried out as follows.

A purpose-built facility for housing captive feral cats is located on the grounds of DSE Frankston at 40 Ballarto Road, Frankston (Victoria). The cat-house consists of two rows of seven pens separated by a central corridor (i.e. a total of fourteen pens). This facility has a sealed concrete floor and walls of sheet metal to a height of 1.2 m. A section of cyclone mesh then extends above this sheet metal to the galvanised steel roof. The cyclone mesh has a curtain of shade cloth stretched around the entire facility to provide a degree of shade to the cats inside. A log was placed in each pen to allow cats to climb above the sheet metal and see out of the facility.

One of the pens is fitted with a camera system to allow remote monitoring and recording of cat behaviour. Three infra-red cameras as well as a visible region camera (and microphone) (located overhead) were fitted to the pen. A 60 watt floodlight was directed through a sheet of ICI Perspex 962 (that acts as filter for infra-red) to provided adequate illumination throughout the pen without disturbing the behaviour of the subject. Mesh cages were fabricated to protect the cameras and spotlight from being accessed by the subject. This pen was further darkened by fixing plastic sheets to the cyclone mesh section. Bricks were used to block light from entering the pen at ground level. The pen was darkened to ensure that a consistent level of lighting was achieved as previous work has demonstrated that the cameras provided poor vision in uneven light conditions. A water bowl and a litter tray were also provided in the pen.

Feral cats were prepared for trial at least twenty-four hours prior to the initiation of the trial. This involved light sedation (˜4 mg/kg Zoletil) and clipping fur at the throat and forelegs. A ˜0.02 ml blood sample was taken with a 1 ml heparinised syringe and 23G needle. The blood sample was analysed for MetHb concentration using a Radiometer OSM-3 haemoximeter. The subject was weighed, sexed and photographed while sedated. The subject was then placed in the ‘trial pen’ of the cat-house and allowed to recover overnight prior to the initiation of the trial. Trials were usually conducted the day after the subject had been prepared and were fully recovered from the sedation by this time.

On the morning of the trial, a bait was thawed and a HSDV pellet was loaded into one end using a trochar. The video recorder was then started and the bait placed in the trial pen. This was done as quickly and quietly as possible to minimise the duration and extent of human presence in the cat-house with the intention of minimising stress to the subject. The behaviour of the subject was then monitored remotely until unconsciousness was observed. On occasion, the pen was briefly inspected to confirm that the HSDV pellet had been consumed or to assess the consciousness of the subject. Written observations were made of the cats behaviour throughout the trial. A blood sample was collected following the collapse of the subject. Subjects were allowed to proceed through the entire toxicosis unless symptoms or behaviour were unsatisfactory (i.e. prolonged toxicosis, poor potential for recovery from sub-lethal dose, etc.).

TABLE 8
Summary Data from HSDV Efficacy Trials (pen)

| | n = | dose rate | t_{coll} (min) | t_{dth} (min) | vomit (%) |
|---|---|---|---|---|---|
| | (%) | (mg kg⁻¹) | [effectiveness (%)] | [efficacy (%)] | [tᵥₒₘ (min)] |
| Overall | 49 (100) | 18.3 | 145 [86] | 57 {113} [70] | 26 [169] |
| success (+) | 34 (70) | 19.0 | 151 [70] | 57 {113} [70] | 12 [211] |
| recovery (−) | 15 (30) | 16.9 | 117 [16] | — | 14 [128] |
| Gender Effects | | | | | |
| Male | 26 (52) | 16.7 | 131 [45] | 58 [30] | 17 [117] |
| success (+) | 15 (30) | 16.7 | 137 [31] | 58 [30] | 4 [85] |
| recovery (−) | 11 (22) | 16.7 | 100 [14] | — | 13 [128] |
| Female | 23 (48) | 20.2 | 159 [41] | 56 {156} [40] | 10 [273] |
| success (+) | 19 (40) | 20.8 | 162 [39] | 56 {156} [40] | 8 [273] |
| recovery (−) | 4 (8) | 17.3 | 100 [2] | — | 2 [nd] |
| Pregnancy Status | | | | | |
| pregnant | 13 (27) | 17.8 | 214 [20] | 68 {175} [20] | 8 [241] |
| success (+) | 9 (19) | 18.0 | 227 [18] | 68 {175} [20] | 6 [241] |
| recovery (−) | 4 (8) | 13.4 | 100 [2] | — | 2 [nd] |
| non-pregnant | 10 (20) | 23.3 | 104 [20] | 46 {139} [20] | 2 [370] |
| success (+) | 10 (20) | 23.3 | 104 [20] | 46 {139} [20] | 2 [370] |
| recovery (−) | 0 (0) | — | — | — | — |

### Example 5

### Field Trial

Feral cats were trapped within a designated area that was to be baited three months prior to baiting and all healthy captured cats were fitted with GPS datalogger/VHF transmitter collars. These collars were programmed to collect a GPS data point every three hours while transmitting a tone at a specified frequency in the 151 MHz band. The VHF tone was transmitted at a rate of 40 pulses per minute (ppm) while the cat was moving switching to 80 ppm after 12 hours of no movement—called ‘mortality mode’.

Baits used in this study were prepared according to the previous examples. Specifically, encapsulated HSDV pellets containing 78 mg of PAPP plus other excipients were implanted into each bait during manufacture. Baits were air dried and then frozen for three days prior to application.

Baits were spread on a shade cloth hammock where they were thawed, sweated and treated with Coopex residual insecticide. A helicopter flying at approximately 20 knots was used to aerially distribute baits at a density of approximately 50 baits/km² (i.e. 5 baits dropped every 10 seconds). A GPS waypoint was created each time that baits were dropped. A total of 3585 baits were dropped from the helicopter. Ground-based baiting was also undertaken due to concerns about aerially delivered baits becoming stuck in dense vegetation. An additional 578 baits were placed in the centre of the tracks at 100 m intervals within the baited zone on the same day. Baiting density overall was approximately 69 baits/km².

Survival of radio-collared cats was monitored two weeks after application of baits using an Australis VHF receiver (Titley Electronics) fitted to a handheld yagi antenna or a uni-direction whip antenna fitted to the roof of a vehicle. Transmitters were recovered if they were found to be in ‘mortality mode’. Photographs and GPS waypoints were recorded at sites where cat carcasses were found. Where possible, cause of death was established. PAPP toxicosis was confirmed by assessing colour of soft tissues in the mouth and or presence of bait in the stomach. Carcasses were removed from the site and frozen.

Eight feral cats were known to be alive when baits were distributed. Four cats died as a result of bait consumption as determined by inspection of stomach contents (0400, 2600, 3000 and 3600). The body of Cat 3800 had deteriorated sufficiently to preclude confirmation of PAPP toxicosis when it was recovered. However, the GPS data indicated that the movement ceased on the day of baiting so it is possible that this cat also consumed a bait.

Three feral cats were found to be alive during the post-baiting monitoring period. One of these individuals (1200) was consistently found to be outside the baited area. An additional 10 baits were laid in its immediate vicinity. This animal was found to have died from PAPP toxicosis as determined by inspection of stomach contents.

TABLE 9
Morphometric details and fate of radio-collared
feral cats following baiting

| ID | Morphometric | Note |
|---|---|---|
| 0400 | Male 3.0 kg | Animal died. Multiple baits in stomach. |
| 1200 | Male 3.4 kg | Animal not in baited area. Animal died 2 days |
| | | following distribution of additional baits in |
| | | area of animal. Bait in stomach. |
| 1400 | Male 3.6 kg | Survived. |
| 1600 | Male 3.3 kg | Survived. |
| 2600 | Female 2.6 kg | Animal died. Multiple baits in stomach. |
| 3000 | Female 2.6 kg | Animal died. Multiple baits in stomach. |
| 3600 | Female 2.8 kg | Data stopped. Animal had multiple baits |
| | | in stomach. |
| 3800 | Male 3.4 kg | Animal died. Furred skeleton when recovered. |

It can be seen that bait uptake by the collared cats was high and mortality and efficacy of baits substantive.

Finally, it is to be understood that various alterations, modifications and/or additions may be introduced into the constructions and arrangements of parts previously described without departing from the spirit or ambit of the invention.

1. A delivery device for use in the control of a target animal species, the delivery device comprising:
(a) a core containing a control agent for the target animal species,
and
(b) an impermeable coating enclosing the core, the coating being selected to provide exposure of the core in the gastrointestinal tract of the target animal species;
wherein the coating of the delivery device has a hardness such that the coating is not readily breached upon mastication by a target or non-target animal species and further wherein the delivery device will not pass through a Tyler 5 mesh.

2. The delivery device of claim 1 wherein the coating of the delivery device has a Shore D hardness of at least 50.

3. The delivery device of claim 1 wherein the coating of the delivery device has a Shore D hardness of at least 70.

4. The delivery device of claim 1 wherein the delivery device will not pass through a Tyler 4 mesh.

5. The delivery device of claim 1 wherein the target animal species is selected from the group consisting of felids, canids and mustelids.

6. The delivery device of claim 1 wherein the target animal species is a cat.

7. The delivery device of claim 1 wherein the control agent is selected from the group consisting of a toxicant, an appetite suppressant, a contraceptive, and a vaccine.

8. The delivery device of claim 7 wherein the control agent is a toxicant wherein the toxicant is p-aminopropiophenone or a salt thereof.

9. The delivery device of claim 1 wherein the core represents from 10% to 90% w/w of the delivery device.

10. The delivery device of claim 1 wherein the core represents from 30% to 70% w/w of the delivery device.

11. The delivery device of claim 1 wherein the core contains a solubilising agent.

12. The delivery device of claim 1 wherein the core contains a disintegrant.

13. The delivery device of claim 1 wherein the coating provides rapid exposure of the core in the gastrointestinal tract of the target species.

14. The delivery device of claim 1 wherein the coating provides rapid exposure of the core in the stomach of the target animal species.

15. A method of controlling a target species in an environment containing the target species the method utilising the eating behaviour of the target animal species to selectively control the target animal species.

16. The method of claim 15 wherein the eating behaviour is the degree of mastication of food eaten by the target animal species.

17. The method of claim 16 comprising laying a bait in the environment, the bait including:
(i) a delivery device including:
(a) a core containing a control agent for the target animal species;
and
(b) an impermeable coating enclosing the core, the coating being selected to provide exposure of the core in the gastrointestinal tract of the target animal species;
wherein the coating of the delivery device has a hardness such that the coating is not readily breached upon mastication by a target or non-target animal species and further wherein the delivery device will not pass through a Tyler 5 mesh; and
(ii) an attractant.

18. The method of claim 17 wherein the baits are laid in the environment at from 10 to 1000 baits per square kilometre.
